(19) United States
(12) Patent Application Publication
(10) Pub. No.: US 2016/0292811 A1
(43) Pub. Date: Oct. 6, 2016

(54) METHOD FOR THE INTERACTIVE PARALLEL PROCESSING OF DATA ON A CLUSTER WITH THE GRAPHIC INPUT/OUTPUT ON A VISUALISATION DEVICE

(71) Applicants: ALMA MATER STUDIORUM - UNIVERSITA' DI BOLOGNA, Bologna (IT); ISTITUTO NAZIONALE DI FISICA NUCLEARE, Frascati, Roma (IT)

(72) Inventors: Rosa BRANCACCIO, Bologna (IT); Franco CASALI, Bologna (IT); Maria Pia MORIGI, Bologna (IT); Giuseppe LEVI, Bologna (IT); Matteo BETTUZZI, Bologna (IT)

(73) Assignees: ALMA MATER STUDIORUM - UNIVERSITA' DI BOLOGNA, Bologna (IT); ISTITUTO NAZIONALE DI FISICA NUCLEARE, Frascati, Roma (IT)

(21) Appl. No.: 14/442,573

(22) PCT Filed: Nov. 15, 2013
(86) PCT No.: PCT/IT2013/000322

§ 371 Date: May 13, 2015

(30) Foreign Application Priority Data
Nov. 16, 2012 (IT) RM2012A000567

(51) Int. Cl. G06T 1/20; G06F 9/44; G06F 9/50; G06T 11/00; G06F 3/0484

(52) U.S. Cl. CPC G06T 1/20; G06T 11/003; G06F 3/0484; G06F 9/5066; G06F 9/4443; G06T 2210/52; G06T 2210/41

(57) ABSTRACT

A method of calculation that is simultaneously parallel and graphic able to run on clusters with various operating systems such as for example Windows HPC and Unix. A program realized according to such a method is able to perform a parallel calculation on a cluster, by means of a message-passing system (for example MPI), and at the same time to visualise an interactive graphic interface (GUI). The program according to the method runs in parallel and executes the calculation in parallel as defined by user instructions that are provided through a GUI. The GUI is generated, managed and visualised within the cluster itself and therefore it is not necessary to connect to it by an external PC.

The developed method is able to perform the reconstruction for example of tomographic images in parallel and to show the graphic results on video, even partially and interactively.

The present invention concerns a method of interactive parallel processing of data on a set of several computers connected to each other in a network and sharing the same operating system (cluster), with graphic input/output on a visualisation device.

More in detail, the present invention concerns a calculation method that is at the same time parallel and graphic, for clusters with various operating systems such as for example Windows HPC and UNIX. A program realised according to said method is able to carry out parallel calculation on a cluster, by means of a message-passing system (for example, MPI, “Message Passing Interface”), and at the same time to visualise an interactive graphic interface (“Graphic User Interface” or GUI, i.e. a set of menus for opening/closing files and sequences of images, panels for processing and graphic visualisations, buttons for the user interface and for the input of parameters). The program according to the method runs in parallel and executes the calculation in parallel as defined by instructions from the user that are provided through the GUI. The GUI is generated, managed and visualised within the cluster itself and therefore it is not necessary to connect to it from an external PC. The program according to the method is able to self-adapt to the number of ranks and nodes at disposal and is able to use them when they are needed for the calculation, to put them on wait when they are not necessary and to monitor their progression when they are running. The developed method is therefore able to carry out the reconstruction for example of tomographic images in parallel and to show the graphic results on a video. The method therefore can be applied to any software of processing of images of any type (medical imaging, non-destructive tests for the industry and the cultural heritage), but also to other types of data: it could even control one or more physical instruments provided that they are connected in some way to the cluster (for example, by network, USB, card, wireless).

### STATE OF THE ART

In the Information Technology, a cluster is a set of computers connected to each other by means of a communication network and sharing a same operating system.

The clusters, whatever the operating system be, are designed to process very large and complex data sets in a short time but they do not provide for the possibility of carrying out graphic representations of the results in a parallel program. Since the clusters have become less expensive and affordable by most subjects, their computing power could represent an enormous advantage for applications requiring intensive calculation and graphics. Unfortunately, this possibility has been substantially ignored, exactly because of the necessity of eliminating any graphic part from the programs running in parallel on a cluster. Succeeding, therefore, to obtain a method allowing not to sacrifice the graphics in favour of the parallelism means, as a matter of fact, to be able to exploit completely the resources of a cluster and optimise their use.

All the clusters, both in a LINUX (UNIX) and Windows operating environment, have a management system of the resources of the cluster by means of which one has to pass in order to submit a job (computing work, that is typically but not only parallel, and that can have different features and makes use of different resources).

In Windows HPC, for example, this program is termed “HPC Job Manager” (JM) and, on one hand, it allows to create parallel jobs with different characteristics (number of used CPU, redirected input/outputs, dimension of the available RAM, number of tasks, utilisation time, etc.) and, on the other hand, it manages the priority among the job of different users. This program is the only way to submit parallel jobs that can take advantage of all the resources of the cluster (unless one starts the program “by hand” on all the nodes, as many times as there are processes that one wishes, verifies that all the processes have started correctly, etc.) The parallel calculation system managed by the JM provides that the jobs are not interactive because they are executed with priorities established by the same JM on the basis of the available resources and therefore not in real time. In these conditions, any request of input would block the job and all the processes in the queue after it. For such a reason, by default, the console does not run (no interactivity) and the graphic input/output is not enabled (GUI).

In order to get around this problem, SOA (“Service Oriented Architecture”) systems have been developed, that are composed by two separate programs: one is a parallel program and the other is an interactive and graphic program. The GUI is part of the non-parallel (sequential) program and is located on a “terminal” computer external to the cluster and communicating with it by a local network or Internet. On the cluster, the parallel and not interactive job runs, when the JM assigns to it the resources, and on the terminal runs the sequential (nonparallel) GUI, which visualises the results once they are available. This solution is slow, complicated to develop (and, to the knowledge of the Inventors, it has not been really applied), dangerous for the privacy (the data and results pass through a network), it is very little flexible, it provides that all the parameters are predetermined (there is no possibility for a preview of the results). The only advantage is that a plurality of users can take advantage of the cluster, but this is nonsense for applications wherein the privacy and the speed of execution is essential (medicine, industry).

Moreover, it is not immediate to integrate a parallel and graphic program with JM and here there are two different methods that we see in the following.

A first method, conceptually simple but that places an handicap on the calculation efficiency, consists in obtaining the parallelisation by replicating the program N times and by statically differentiating the standard input. This method provides that one copies the data on all the nodes and that, subsequently, one collects the results scattered on the same nodes.

A second method (that is more complex, uses message-passing system, is used in connection with problems that are not completely parallel) provides that one replicates the program as for the first method but with an only non-parameterised standard input. In such second method, the program contains in itself all the algorithms for the parallelisation and dynamic (dynamic, but not interactive) management of the processes, and allows to process only predetermined operations: the input parameters will have to be already established before starting the program, and only at the end of the calculation it will be possible to collect the data, visualise them and understand whether the used parameters have given rise to the desired result.

The methods in the patent applications US2010/218190 A1 and US2008/148013 A1 are clearly applications of the second method because they exclude the possibility of the graphic interaction with the user to the benefit of the only parallel calculation. Both the methods make use of the message-passing system to manage in a dynamical (not interactive) way the steps of calculation, opening and storing of the data. The described matter does not allow in any way the use of these methods in a graphic and interactive environment.

Summarising, in order to execute a job of a program that works with N tasks in a traditional way on a cluster, depending on the chosen method, one has to face the following disadvantages:
creating N files of parameterised inputs (and, to this end, writing a dedicated software);
creating a folder with the same path/name on all the nodes and copy into it the executable and all the parameterised files;
creating a folder with the same path/name on all the nodes and copy into it all the data to be processed;
running a parallel job and waiting that all the tasks are concluded;
collect on every node the portion of results;
in any case, waiting for the final result to verify the correctness of the calculation parameters;
impossibility of interrupting the operations of calculation (unless one loses what in the meantime has been done and without knowing the current progress of the operations),
necessity to re-write whole or in part the code to adapt it to different sets of data and situations.

Summarising, both in the first method, and in the second method, one needs to eliminate any graphic and interactivity functionality to be able to make the parallel calculation work, elimination that has confined the clusters use exclusively to the framework of the academic research for non-interactive and non-graphic calculation. Indeed, to the knowledge of the inventors there is no method to develop a program with interactive graphic interface and that at the same time allows the parallel calculation of reconstruction of images on the basis of the data from sensors (imaging).

For example, the application of commercial software COMSOL multiphysics, that runs also on cluster, can be used on cluster only after having established the correct parameters in interactive way with the nonparallel software and after it ran in background on cluster only with fixed parameters. This example, once again, shows how, according to the prior art, one has to renounce without compromises to the interactivity and graphics in order to have the calculation parallelism.

There are also more recent methods that try to overcome the above described limitations, methods that are realised by combining a plurality of application tools and/or by adding hardware outside the cluster. An example is the one described in the document W02008097437, wherein one describes the possibility of doing rendering on a cluster so as to process large volumes of data. The solution proposed in this patent application provides for the use of a plurality of applications in order to separate the interactive graphic part from the parallel one, losing the possibility to control completely each phase of the processing step. As a matter of practice, it deals with a complicated and not much efficient SOA (“Service-Oriented Architecture”) method.

An important example of the use of SOA is the solution adopted by Microsoft to execute Microsoft Excel on cluster (see details on the Internet page htt://technet.microsoft.com/en-us/library/ff877825(v=ws.10).aspx). In order to use Excel on cluster, one needs to use one of the three different SOA solutions, partially graphic and interactive, that have the main disadvantage of being complicated and that provide that the user has specific technical skills in order to be able to use the cluster.

### OBJECT OF THE INVENTION

It is object of the present invention to provide a method of execution, on a parallel calculator, of the interactive visualisation module of an imaging device, that solves the problems and overcomes the disadvantages of the prior art.

### SUBJECT MATTER OF THE INVENTION

It is subject matter of the present invention a method according to any of the enclosed claims.

It is further subject matter of the present invention a computer program, characterised in that it comprises code means configured in such a way that, when operates on an electronic parallel computer, realise the method according to the invention.

It is further subject matter of the present invention a memory medium readable by a computer, having a computer program memorised on it, characterised in that the program is the computer program according to the invention.

The enclosed claims are integral part of the present description.

According to an aspect of the invention, the method is able at the same time of:
executing a parallel program, for example with message-passing system MPI;
visualising the GUI of the same MPI parallel program directly within the cluster;
recalling the ranks from their waiting function without consuming system resources;
making the program interactive as well as parallel;
distributing efficiently the work among the ranks;
reading/storing the data necessary for the execution of the parallel jobs in an efficient way.

One specifies here that the MPI is a family of message-passing systems, within which there are various versions, depending on the operating system and functionalities. The message-passing systems are notoriously used to manage the messages among various processes of calculation, for example in a parallel calculation. In the following, where it is not specified, one understands that all the communications between processes occur by using a message-passing system.

### DETAILED DESCRIPTION OF THE INVENTION

The invention will be now described by way of illustration but not by way of limitation, with particular reference to the drawings of the enclosed figures, wherein:

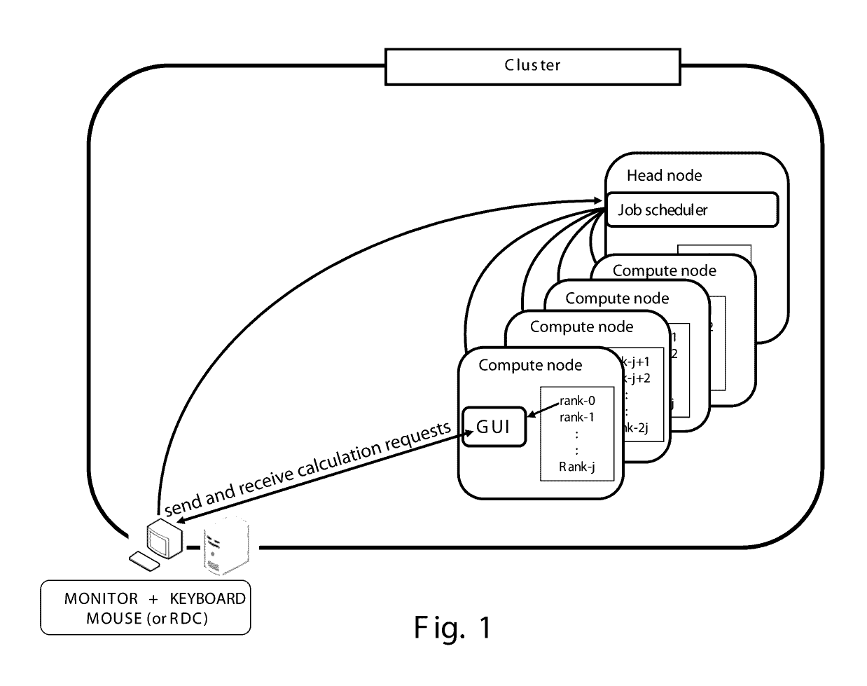

FIG. 1 shows a block diagram of the method for parallel calculation according to an embodiment of the method according to the invention;

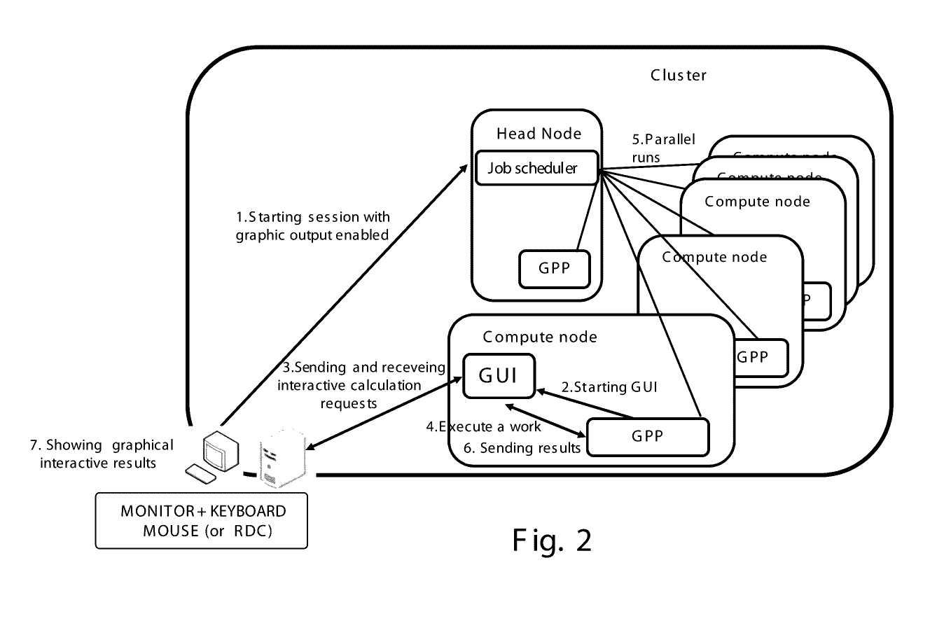

FIG. 2 shows a mixed block diagram and flow chart of the method according to the invention;

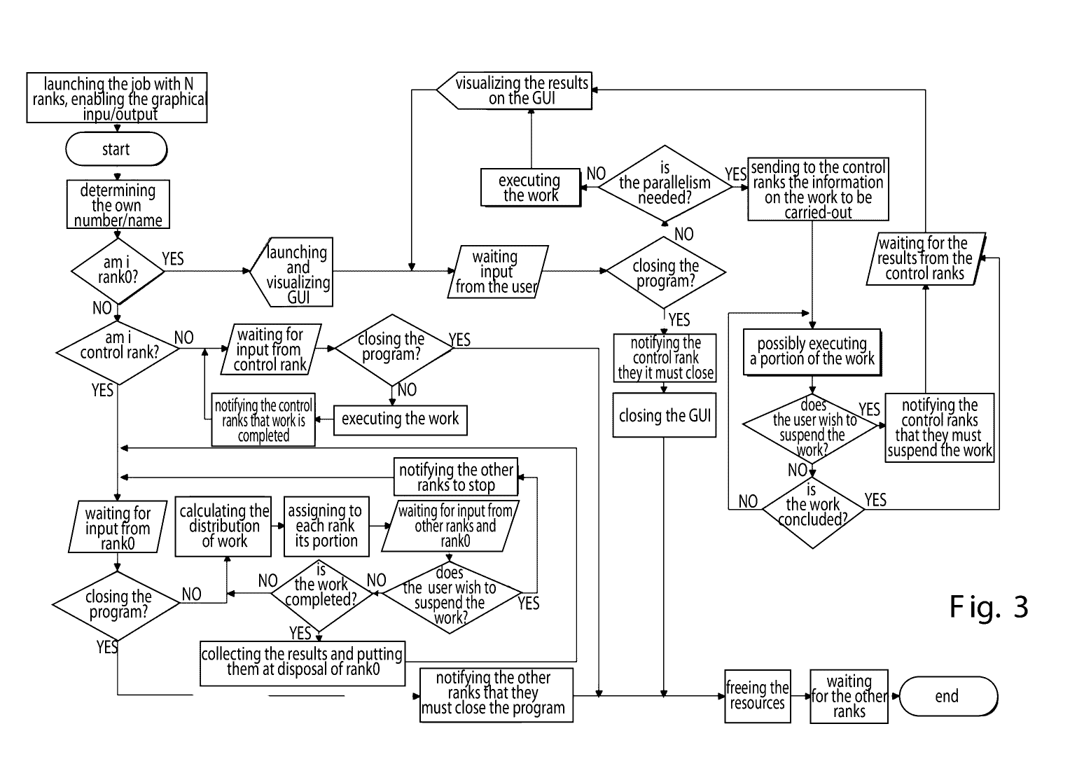

FIG. 3 shows a flow chart of the method according to the invention;

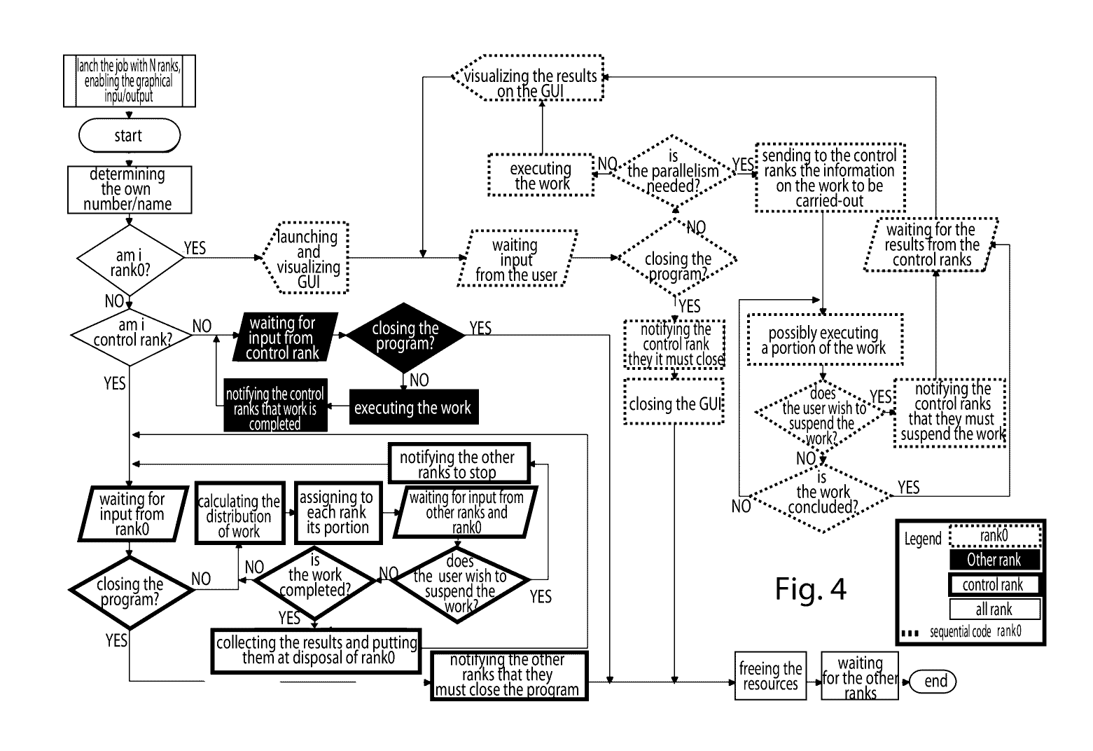

FIG. 4 is the same of FIG. 3, wherein the portions of code relevant to the various ranks are highlighted, and in particular the portion of sequential code executed by the only rank0;

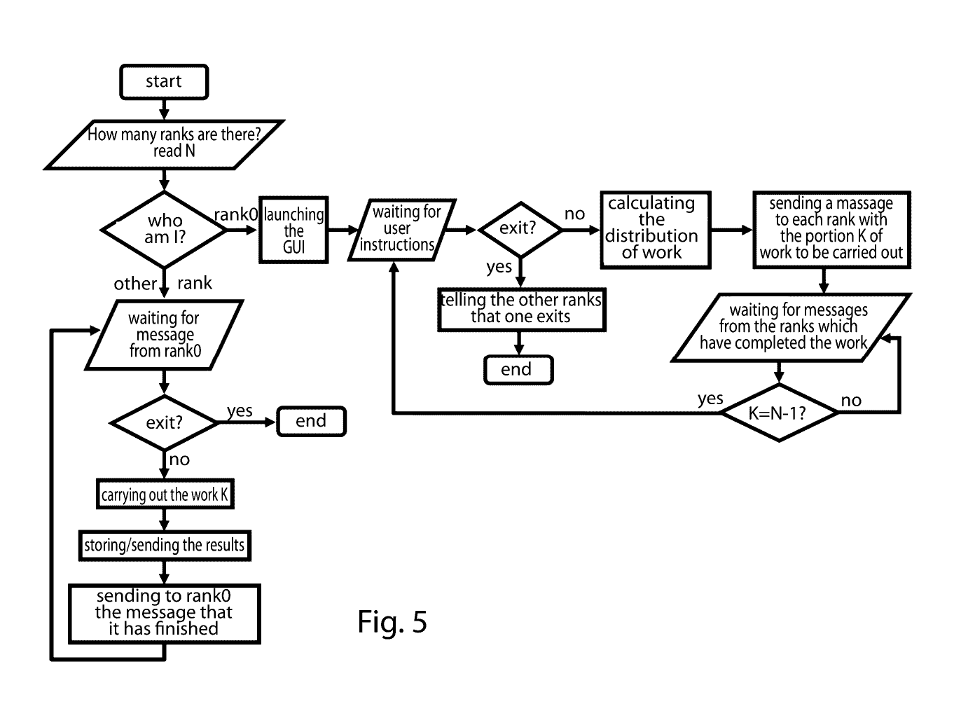

FIG. 5 shows a flowchart of an embodiment of the invention, wherein the only rank0 carries out the sequential functions and those of control rank that organises the work of all the ranks.

Making reference to figures from 1 to 4, it is here described the basic method according to the present invention that is executed on a cluster. The cluster comprises a series of nodes and utilises a message-passing system. As in the prior art, the calculation or processing work is subdivided among N processes that execute the same parallel processing program written according to the method of the invention (in the figures and in the following, briefly termed GPP, “Graphic Parallel Program”), the N processes being termed ranks, rank0, rank1, . . . rankN-1 and being distributed on one or more calculation nodes of the cluster.

To the end of realising interactivity and graphics functions simultaneously with the parallelism, according to the method, in the configuration and GPP starting step, it is ordered to the message-passing system of the cluster to enable the graphic input/output on one of the nodes, in particular, on that node, one of the ranks defined as rank0 is selected. Rank0 will be the only that manages the GUI. This enablement acts, as a matter of fact, as if one connected a virtual monitor to the node of rank0 which otherwise would be like all the other nodes (and processes that is located on each node) i.e. totally closed towards the outside (unable to access the graphics and read from keyboard or mouse).

In this framework, rank0 executes a portion of the processing program dedicated only to it (in the following synthetically termed as “sequential”). It deals with a part of the program, which is, as a matter of fact, a sequential code that only rank0 must execute. To all intents and purposes, the portion of code executed by a rank0 manages the GUI in a way completely independent from the other processes, for which the GUI does not exist. According to the method, one obtains therefore the generation of the GUI directly within the cluster itself and it is no more necessary to add other devices and/or applications to obtain this result. Rank0 is therefore able to monitor the graphic events generated by the GUI and the operating system and, only when the instructions of the user or the load of calculation to be carried out requires it, rank0 sends a message to the other ranks, passing, as a matter of fact, to the parallel code.

With the execution of this sequential portion, rank0 runs the GUI and it can do it because one has previously enabled the graphic input/output on the node whereon it runs. Indeed, normally in a cluster the nodes do not have exchanges with the outside, they are only dedicated to the pure calculation and therefore do not come out to be enabled for the graphic output and/or interactivity.

At this point, once started the GUI, rank0 waits for instructions from the user who utilises the program of parallel processing. As soon as these instructions arrive (which will deal with the specific processing to be carried out, or will be commands to terminate any calculation), rank0 provides them to one or more control ranks. These control ranks organise the calculation work and distribute it to the various ranks (ranks that one can term “calculation” ranks, among which possibly there are also the same control ranks and rank0). Moreover, the control ranks instruct the calculation ranks on how to save the data that are result of the calculation that each one carries out. In general, it deals with putting the results at disposal of rank0. The control ranks control, moreover, the calculation ranks and, when they have completed their horn work, invite rank0 to collect the results.

At this point, rank0, visualises on a visualisation device (even in the same GUI) the calculation results (for example calculation on images coming from medical images acquisition devices).

FIG. 5 is a more specific embodiment of the method, wherein the control ranks are constituted by the only rank0. As a matter of practice, rank0 executes the sequential portion of the processing program and also the parallel part, organising the work of the other ranks and possibly executing itself also a part of the organised calculation work.

In an embodiment, the new method according to the invention provides that the relevant job (for example, for the processing of tomographic images) can be submitted both by means of the utilisation of the job manager and by means of a dynamic batch file (bat file) that, contrary to the prior art, since it does not contain the parameters necessary to the calculation (obtained interactively by means of GUI), is never to be modified.

According to an aspect of the invention, at the moment of the start by JM, the field relevant to the standard input can be empty and advantageously it will be so. This means that it is not necessary neither to redirect the standard input nor to create an ad-hoc parameterised one. At the moment of the execution of the program, rank0 will start the GUI and, as a matter of fact, one will have a graphic and interactive input on an only node (that of rank0 on which the graphic output will be enabled). The JM will manage and monitor the program as if it were a single job replicated N times (as many times as there are ranks that one wants to have at disposal) but with a same static standard input. Therefore, on the side of the JM, it is as if the program simply executed a series of static instruction in parallel (as in the first programs of brute force of UNIX) while the input is graphic and interactive and comes from the GUI. Analogous and identical observations hold for the output.

### Example of a Particular Embodiment of the Method

As previously illustrated, the method, in order to be realised, provides different steps that will be now illustrated with examples of realisation. Such examples are only one of the practical modes by which one can realise the proposed method. In particular, one illustrates the following steps:
enabling of the graphic output;
structure of the program;
waiting of the calculation ranks;
acquisition and visualisation of the state of the program;
method for the parallelisation on only one node;
method for the parallelisation on a plurality of nodes;
method for the parallelisation with a ranksave;
method for the parallelisation with intensive calculation.
   Practical Examples for Enabling the Graphic Output with a Message-Passing System

By way of mere example, one gives here the commands relevant to some reference operating systems (Windows and LINUX) for enabling the graphic output on the node of rank0. Although the commands vary depending on the operating systems, the functioning logic of the method according to the invention keeps identical.

In particular, it will be necessary to preliminary have the executable available on all the interested nodes in a working folder (not to be confused with the folder wherein the data are located) that has the same name on every node. Obviously, this operation can be executed by an installation program.

Both in Windows and LINUX (UNIX) one creates a parallel job with the desired characteristics (number of nodes and processes and more) by means of the JM as in the prior art.

It is then necessary to add to the created job the following options that are different for the two operating systems, Windows and LINUX respectively:

| | |
|---|---|
| (1) | /env:HPC_ATTACHTOCONSOLE=TRY |
| | /env:HPC_ATTACHTOSESSION=TRY /env:MPICH_ND_ZCO |
| (2) | Environment=DISPLAY=:0 |

One runs then the program with MPI as usual.

It should be noted that the command (1) valid for Windows and the command (2) valid for the LINUX's allow to enable the graphic input/output on the node whereon rank0 is located. Indeed, for Windows the two options tell to the message-passing system to connect the interactive console to the job and to enable the graphic input/output and not to start the program till one has succeeded to obtain these two characteristics; for LINUX the command “DISPLAY=” orders to the message-passing system to enable the graphic output and the option “:0” specifies that one needs to do it on the node to which one just connected. In particular, for LINUX it will be necessary that the cluster supports the X-Window System (standard graphic manager for the UNIX/LINUX).

Analogously, in order to execute the same program on Windows 7 one will add to the command line of MPI the option

(3)—localroot

In all the operating environments, it is possible to create installation files that execute the above described points in an automatic way. It is moreover possible to create dynamic batch files that contain the above mentioned lines and that therefore allow the user to avoid to recall each time these commands to run the program: one will have an only icon (on the desktop or in the programs menu or where one wants) on which, by clicking two times, one stars the program, as for any other commercial program (for example: Word).

Examples of Structure of the Program that Realises the Method According to the Invention

With the measures of points 1, 2 and 3 of the previous list of command lines, the user interface would be visualised as many times as there are ranks started and therefore N replies of the programs would be obtained. As a matter of practice, each reply would be then totally independent and one should tell manually to each interface what is the work to be done. Moreover, on HPC cluster there would be no way to visualise the interfaces on the “non-main” nodes which would remain eternally on hold, waiting for instructions.

It is first necessary that the graphic part of the program is managed always and only by an only process. Once defined the rank0 as a process that is located on the node whereon the graphic output has been enabled, the choice that one has made has been that of assigning to rank0 the management of the graphics and of the other processes that normally are waiting for instructions and perform calculations only when rank0 assigns to them a task.

Making reference to FIG. 5, let's suppose one has N processes running, there will be ranks from 0 to N-1. At the start of the program, the N processes are generated and each of them executes the same code. All enter in the main (entry point in a program) and the first operation that one does is to ask the message-passing system the number that has been associated to them and how many processes there are. One must understand that, being the program parallel, all the processes do this operation independently. Thus, each process acquires information on itself (and its number), on which node it finds, and on its operating environment (the total number of ranks).

At this point, the actions of the ranks differentiate depending on their numbers simply by using an if. If the process that enters the if is rank0, it will be concerned with the starting of the user interface and the waiting of instructions from the user, if the process has a number different from zero then it will enter a “do” cycle that has the task of making the process wait for messages from rank0 about what is to be done. Each rank different from zero will remain in the “do” waiting for instructions, till it will not receive the message that can indicate to enter in a specific function to execute one or more portions of work or the “STOP” message that provides one terminates the execution of the program (see in the following for an advantageous implementation of this waiting cycle).

The choice that has been done in this example of the method according to the invention is to associate with some “define” integer numbers to particular messages that can be exchanged between the processes. In this way, the commands that rank0 sends to the other processes are univocally defined. On the basis of the sent message/command, the other ranks will enter in the function associated to it in order to execute a particular type of calculation according to the specification and parameters that the user will have given to rank0 and that the latter will have communicated to the other ranks.

### Example of Realisation of Waiting and Recalling of the Calculation Ranks

Rank0, passing through the if cycle, initialises and visualises the user interface whilst the other ranks enter a do cycle waiting for a Bcast by rank0. This point is interesting, in general in the parallel programs one doesn't make the process wait for a Bcast, this is considered almost an error of programming, whilst in our case it is a trick to put on hold the other ranks, while also rank0 waits for instructions from the user. When the user asks, through the interface, the program to perform an operation, rank0 executes it alone if it is trivial (opening an image, visualising it, performing simple calculations, etc), or it sends the Bcast that unblocks the other ranks to start the parallel calculation. The calculation ranks receiving the message enter in the relevant function and each executes a portion of calculation and gives back the result to rank0.

In the following, an example of main of a program is given:

int main(int argc, char* argv[ ]) {

| | |
|---|---|
| int | rank=0,size=0,mess=NOMESSAGE; |

| // initialization of the graphic libraries | |
|---|---|
| ... ... ... | |
| // initialization of the MPI libraries | |
| MPI_Init( &argc, &argv ); | |
| // Other initializations | |
| ... ... ... | |
| // one differentiates the actions | |
| // depending on the processes | |
| MPI_Comm_rank( MPI_COMM_WORLD, &rank ); | |
| MPI_Comm_size( MPI_COMM_WORLD, &size ); | |
| if(rank == 0 ) { | // root process |

... ... ...
// one starts the GUI
RunUserInterface( );

| | |
|---|---|
| } else { | // the other non-zero ranks |

// one puts the other processes on hold
// waiting for instructions from RANK0

do {

MPI_Bcast(&mess,1,MPI_INT,RANK0,

MPI_COMM_WORLD);

switch(mess) {

case(STOP) : {

break;

}
case(RECEIVE_DATA): {

Parallel_Receive_Data_OtherRanks( );
break;

}
case(...): {

...
break;

}

... ... ... ... ... ... ... ... ... ... ... ... [ other messages/functions ] ...

... ... ... ... ... ... ... ...

}

} while (mess != STOP );

}
// Free graphical resources
// other frees
... ... ...
// one waits that all the processes arrive here
MPI_Barrier(MPI_COMM_WORLD);
// one closes MPI
MPI_Finalize( );
return 0;

}

The other processes therefore are active but “sleeping”, waiting for instructions. If rank0 sends them a message, they will enter in the relevant routine and they will execute what is provided from the function as a consequence of the received message. In general, then, rank0 will again send them the information and parameters on what has to be done. When they will have finished, the other ranks will come back in the “do”, waiting for instructions, whilst rank0 will come back and wait instructions from the GUI

One remarks that rank0 can also receive further instructions from the GUI while one executes the calculations in parallel and in such a case it will have to take them into account and execute them (for example: while one is still executing a parallel calculation and an instruction to stop the work arrives from the GUI, in that case rank0 communicates it to the other ranks and one suspends execution until the user decides to resume it or abandon it completely). If the other ranks receive the message STOP, they exit from the do, when all the processes have carried out the frees of the memory one exits (the command MPI_Barrier makes one continue only when all the ranks have reached that line of code).

There exists various mode of parallelisation of the single operations, and the methods depend also on whether there are one or more nodes. Therefore, the first operation that rank0 will execute will be that of asking to all the other ranks which ranks they are, on which cluster node they find, and that of verifying that there are no problems/errors.

### Example of Acquisition and Visualisation of the State of the Program

As just above illustrated, a first parallel operation, carried out by the program automatically during the start, is the detection of the state of the program: how many ranks there are, on which nodes they find themselves, etc. In order to do that, rank0 sends the message WHEREAMI to all the others, which then, by means of send and recv, send to rank0 the various information. Once received the information, rank0 visualises them within a colour graphic dynamic element and the other ranks come back to their do cycle.

This graphic element allows having always a clear picture of what the various processes are doing. In particular, it is created dynamically by rank0 at the start, and a number of luminous symbols relevant to the ranks is not predefined, it depends on how many ranks there are, therefore, it is dynamic and flexible. During the parallel operations, the ranks that are working will have for example a red luminous symbol, those that are waiting will have grey symbol and those that have finished their work and have come back to the do cycle will have green colour. Obviously, there is no way for the various ranks to access this graphic panel, so that rank0 will always be charged to update it on the basis of information that arrive from the other ranks.

There exist different methods to parallelise the calculation and collect results. We will see in the following some of them, without being exhaustive, utilised in the method according to the invention.

Basic Method for Parallelisation with an only Node

The basic method for parallelisation, if all the processes find themselves on the same node, is obviously to provide each of them with the information on where the images to be processed are, tell them which operation is to be done and with which parameters, and then manage only the subdivision of the work. In this case, rank0 sends all the necessary information to the various ranks, assigns to each a task and then waits that one of them has finished. When a rank has finished, it communicates this to rank0 which keeps track of the progression of the work: if there are other data to be processed, rank0 will assign a new load, otherwise rank0 will order to enter again the waiting do cycle. In this method, each rank opens and stores the data independently from the other ranks.

Basic Method for Parallelisation with a Plurality of Nodes

The simplest method to parallelise a work, independently from which computer (node) the various processes are on, provides that an only rank opens and saves the data and send them to the calculation ranks for their processing. A simple solution is that rank0 itself will open the data, send them to the calculation ranks, receive them and finally save and visualise them interactively. The management of the calculation ranks is analogous to the previous case. This method makes sense if the operations of opening, sending, receiving and saving are fast with respect to the calculation to be performed, otherwise the fact that rank0 has to deal with these operations alone, besides the management of the various ranks, could represent a bottleneck.

Parallelisation with Ranksave on a Plurality of Nodes

When the ranks find themselves on a plurality of nodes and the operation of reading/saving requires more time, it is advantageous to choose a rank on the node of rank0 in order to assign to it the only duty of saving. In this case, rank0 first looks for a rank that is on its same node and assigns to it the name of ranksave. Then the calculation and management proceeds as in the previous cases apart from the fact that the calculation ranks will send the data to be saved to ranksave. Rank0 will always know the status of progression of the work and can always collect the data saved by ranksave, in order to visualise them interactively. This method solves the problem of the bottleneck in the opening/saving of data.

### Parallelisation in the Case of Intensive Calculation

In some cases, the calculation is actually very heavy as for example in the case of the tomographic reconstruction. In order to reconstruct the single image with an only rank in case the image is very large (more than some MB), one can take even several minutes. For this reason, parallelising on the number of images does not make sense, above all in case the images are few ones, but it is more convenient to parallelise the calculation of the single reconstructed image.

In the example of the tomographic reconstruction, in order to obtain the slice, it is necessary to process many linear projections and then backproject them on the slice to be reconstructed. The projections are absolutely independent and form an image termed sinogram.

In this case, rank0 sends to all the other ranks the sinogram (or the portion of it that they must process), the geometrical parameters and the information necessary to the calculation, then carries out a calculation on how many projections must be processed and how many processes there are, in order to subdivide the work. Each rank processes and projects independently a part of the projections by summing the results on a matrix that has been initialised to zero. In such a way, at the end of the calculation, each rank will have in memory a slice whereon only some lines of the sinogram have been projected. The final result is to be “reduced”, i.e. one has to perform a summation of all the matrices of all the ranks. In MPI there is a function adapted to reduce the results, this function only collects all the available matrices of the various ranks and performs a point-to-point operation in order to obtain an only one matrix, in this case the operation of reduction is the sum. Obviously, before proceeding to the step of reduction, it is necessary to insert a barrier and wait until all the processes have finished the calculation.

### ADVANTAGES OF THE INVENTION

In the following, one will illustrate some of the problems of the prior art that have been solved by the present invention. One remarks that the following solved problems are independent of the operating system:
executing a parallel software with message-passing system and graphic output;
visualising the GUI of a MPI parallel program on cluster;
making the program parallel as well as interactive;
distributing the work among the ranks automatically, as a matter of fact masking the parallelism to the final user,
allowing the software to process different data and with different parameters without having to modify the program or the parameterised inputs.

The method allows using a cluster for the parallel calculation with the graphic and interactive output and as a matter of fact this coincides with the solution of all the above listed six problems. According to the state of the art, all the problems above illustrated have never been solved simultaneously and by an only one program.

The global solution of the invention optimises the resources of the cluster, obtaining larger efficiency and the possibility of interactive calculation during visualisation. Moreover, the method automatically solves the problem of the privacy for the processing of sensible data (it is no more necessary to put into a network a cluster to be able to use it) and allows even to control physical instrumentation and therefore to be able to perform processing in real time. The latter two advantages make actually interesting the method proposed for the marketing of the relevant software.

Although one has provided an example of realisation with message-passing system “Message Passing Interface” or “MPI”, the solution of the invention is valid with any other message-passing system, which performs the same indicated functions.

An important advantage in the use of the method according to the invention is the minimisation of the time needed to organise the processing and the end choice of the parameters. Indeed, as already illustrated above, before the method, one needed to use a remarkable amount of time first for the distribution of the data and then for the collection of the results.

Moreover, it is not necessary to wait for the end of the processing in order to be able to visualise the results. This is a most important advantage of the method because if, on one hand, it allows to perform processing in a preview to better establish the working parameters, on the other hand it allows also to interrupt the work if one becomes aware only later on that something is not going as one wished.

Another fundamental advantage is that a program written with the method would appear to the end user all around as a normal sequential graphic program. The user not only need not having specific knowledge in order to use it, but he/she would not even become aware that the program is actually running on a cluster.

Moreover, the method can be perfectly integrated in the job manager.

One summarises the main advantages:
1. The data to be processed can find themselves in any position in the cluster;
2. The program itself asks to the user the parameters that are needed for the processing, only at the moment when they are needed, and distributes them automatically to all the processes; it allows to “test” the result of the processing on an only image by showing in real time a preview and by modifying it interactively;
3. The program calculates automatically the distribution of the work among the ranks, on the basis of the number of ranks and nodes, the amount of work, the node where the various ranks find themselves, the occupation of each one, and auto-adapts itself by minimising the nonparallel times;
4. The program manages the saving and the reorganisation of the results autonomously, the user doesn't notice that the data are located temporarily on another node;
5. The method makes extremely simpler the use of the cluster (by allowing a graphic and interactive traditional programming) and therefore it allows a cluster to be considered for the calculation also by a commercial company that doesn't have time to lose with technicalities; it is not necessary moreover to use the “job manager utility” directly, it is possible to create a dynamic script for the start of the program that encloses the few necessary commands which are always the same and are not to be modified each time;
6. The method allows using interactive software with very little modification;
7. The method allows hiding to the non-expert user all the parallelism, as a matter of fact providing the same user with a traditional GUI absolutely identical to the same program running on an only computer;
8. The method does not require in its use any specific skill in order for it to run in parallel.

The method allows finally integrating the parallelism with the acquisition (management of commercial instruments for which LINUX (UNIX) is very complicated to use). By way of further illustration, one compares in the following table the modes of execution of Excel on cluster with respect to those that are characteristics of the method subject matter of the invention.

| Excel on cluster | Invention method on cluster |
|---|---|
| The GUI is always in a separate | The GUI is generated within the |
| application outside the cluster | cluster itself |
| It is always necessary to access | One can access the cluster even |
| the cluster from a remote | directly by connecting physically a |
| computer | monitor to any of the nodes and/or |
| | by connecting by RDC to the |
| | node of rank0 |
| It is always necessary to have a | It is not necessary to have the |
| local network or Internet in order | cluster in a network, one can also |
| to transfer data and results | access it directly |
| It is a SOA application | It is a only one application |
| (composed by a plurality of | |
| different application) | |
| It is complicated, no company | It is simple, interactive and allows |
| has considered it for commercial | to parallelise already existing |
| software | software on cluster with few |
| | modifications |
| A plurality of users can access | It is better (but not compulsory) |
| the resources of the clusters at | that only one user accesses the |
| the same time, although they are | cluster |
| slowed down | |
| It is compatible with JM | It is compatible with JM |
| The only use of this program | A possible user does not even |
| already requires the knowledge of | notice that the program is running |
| technicalities that are unknown to | on a cluster, all the parallelism is |
| most subjects | “hidden” and managed |
| | automatically, an Excel |
| | programmed with the invention |
| | method would be identical to an |
| | Excel that runs on a normal PC |
| The external PC serves to control | The possible external PC serves |
| the whole SOA system | only to visualise the GUI and it is |
| | not necessary |
| It is a system that in its totality is | It is a system that in its totality is |
| in part sequential and in part | in part sequential and in part |
| parallel, however the parallel and | parallel but with the sequential |
| the sequential parts are | and parallel parts intrinsically |
| separated | interconnected |

One stresses here that the computers of a cluster (nodes) are interconnected with each other by a high-speed local network, but none of them has a monitor, a keyboard and a mouse connected. Instead, the method according to the invention provides that either one connects monitor, keyboard and mouse directly to one of the nodes of the cluster, or one uses an external PC. The fundamental difference is that any graphics is generated on the same cluster and the possible RDC connection (“Remote Desktop Connection”) serves only to visualise it on another PC and not to manage it.

In any case, in an innovative and advantageous way with respect to the prior art:
it is not necessary to construct the files of parameterised inputs;
it is not necessary to copy all the data to be processed on all the nodes;
it is not necessary to have a static and predefined standard input;
it is not necessary a static and predefined standard output;
it is not necessary to collect the data on the various involved nodes;
it is not necessary to wait the end of the operations to verify the correctness of the parameters for the calculation;
it is not necessary to write again parts of the code in the case when the set of data or the parameters of the processing change.

In the foregoing, the preferred embodiment have been described and variations of the present invention have been suggested, but it is to be understood that those skilled in the art will be able to change and modify them without by this falling outside the relevant scope of protection, as defined in the enclosed claims.

1-11. (canceled)

12. Method for interactive and real-time graphic control on parallel processing of data on a set of one or more calculation nodes sharing the same operating system and utilising a message-passing system, the parallel processing of data comprising N processes, with N positive integers, that execute a same parallel processing program, the N processes being termed ranks, namely rank0, rank1, . . . rankN-1, and being distributed on said one or more calculation nodes, the parallel processing of data being executed according to the following steps:
A.3.) one or more control ranks among said N ranks execute the following steps on the basis of user instructions communicated by rank0 by means of said message-passing system:
A.3.1 calculating the distribution, among the ranks, of a calculation work to be executed in response to said user instructions;
A.3.2 sending, by means of said message-passing system, to each rank, information relevant to a respective portion of calculation work to be executed;
A.3.3 waiting for messages, sent by using said message-passing system, from the ranks that have at least partially completed the respective calculation portion;
A.4.) said one or more control ranks establish, on the basis of the messages of step A.3.3, that the calculation work is at least partially completed, and put at disposal of rank0 the data resulting from the calculation work;
wherein, before steps A.3 to A.4, to create a virtual input-output device inside said set of calculation nodes, the following steps are executed:
A.1.) enabling graphic input/output from/to a visualisation device, by means of said message-passing system, for at least the node on which rank0 runs;
A.2.) rank0 starts a user interface GUI on its own calculation node and monitors the arrival of user instructions through the same GUI interface during all the execution time of said parallel processing program;
and the following step is executed after step A.4:
A.5.) rank0 collects the data resulting from the calculation work of steps A.3-A.4 and visualises them on the GUI;
wherein steps from A.3 to A.5 are executed each time that the user gives instructions to rank0, recalculating each time the distribution of the calculation work among the ranks, and wherein the parallel processing program includes a dedicated portion that is executed by the only rank0 and which allows to manage the GUI, realizing as a consequence the real-time graphic control on parallel processing of data.

13. Method according to claim 12, wherein said data are medical imaging data.

14. Method according to claim 12, wherein at least a rank, that is different from rank0 but runs on the same node, utilises the enabling of the graphic input/output of step A.1 to visualise graphical information on said visualisation device.

15. Method according to claim 12, wherein if in step A.2 the user provides a command of interruption of the calculation work, in step A.3 said one or more control ranks communicate the interruption of the calculation work to the other ranks.

16. Method according to claim 12, wherein step A.1 is realised in HPC Windows or Unix operating environment by means of the execution of the following sub-steps managed by a processes manager:
A.1.1.) running a session attaching to it the console;
A.1.2.) running said a session attaching to it the terminal;
said a session being not started until the processes manager succeeds to have at disposal both the terminal and the console.

17. Method according to claim 12, wherein said message-passing system is the protocol “Message Passing Interface” or “MPI”.

18. Method according to claim 12, wherein in step A.4, said one or more control ranks put at disposal of rank0 the data that are result of the calculation work, by executing the following sub-steps:
A.4.1.) determining a destination folder on a specific node;
A.4.2.) assigning the saving of the data to a saving rank among rank1 . . . rankN-1;
A.4.3.) instructing any other rank as to whether saving locally or sending the data by network to the saving rank;
A.4.4.) each rank determines which rank it is among rank0 . . . rankN-1 and on which node it runs, and executes the operation of saving or sending the data, such an operation corresponding to the node whereon it runs.

19. Method according to claim 18, wherein step A.4.1 is realised by interaction with the user through the GUI.

20. Method according to 12, wherein said one or more controlled ranks are constituted by the only rank0.

21. A computer program, comprising code means configured in such a way that, when they operate on an electronic parallel computer, in particular a cluster, realise the method according to 12.

22. Memory medium readable by a computer, having a computer program stored on it, wherein the program is the computer program according to claim 21.
